(19) United States
(12) Patent Application Publication
(10) Pub. No.: US 2010/0123433 A1
(43) Pub. Date: May 20, 2010

(54) VOLTAGE EQUALIZATION APPARATUS AND METHOD FOR BATTERY SYSTEM

(75) Inventor: Zufeng Guo, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: SHENZHEN HUAWEI COMMUNICATON TECHNOLOGIES CO., LTD., Shenzhen (CN)

(21) Appl. No.: 12/546,390

(22) Filed: Aug. 24, 2009

(30) Foreign Application Priority Data
Nov. 19, 2008 (CN) 200810181330.X

(51) Int. Cl. H02J 7/00

(52) U.S. Cl. 320/118; 320/116

(57) ABSTRACT

The present invention provides a voltage equalization apparatus and method for a battery system. The apparatus includes: a mutual inductor or a transformer, which includes a primary winding, a magnetic core and multiple secondary windings; a first switch, connected in series with the primary winding, wherein the first switch and the primary winding are connected in parallel with the battery system; a plurality of second switches, respectively connected in series with the secondary windings, wherein the second switches and the secondary windings are connected in parallel with the cells; and a voltage equalization control circuit, configured to: test voltage of each cell in the battery system and control turning off and turning on of the first switch and second switches.

### CROSS-REFERENCE TO RELATED APPLICATIONS

This application claims priority to CN application No. 200810181330.X filed on Nov. 19, 2008, entitled “Voltage Equalization Apparatus and Method for Battery System”, the contents of which are all incorporated herein by reference in their entireties.

### FIELD OF THE INVENTION

The present invention relates to voltage equalization technologies applicable to a battery system made up of serial cells, and in particular, to a voltage equalization apparatus and method for a battery system.

### BACKGROUND OF THE INVENTION

Rechargeable storage batteries commonly used are characterized by low single cell voltage. For example, the single cell voltage of a lead-acid battery is 2.0V; that of a lithium-ion battery is 3.7V; and that of a nickel-metal hydride battery is 1.2V. In a system that requires a high-voltage power supply, multiple batteries of a same type must be arranged in series to provide high voltage. For example, in a communications system, six lead-acid batteries (cells) are usually arranged in one group to form a 12V battery pack and then four battery packs are arranged in series to form a 48V battery system. In a laptop, three to four lithium-ion batteries are usually serially arranged to form an 1.11V or 14.8V battery system. However, because every single battery is different in voltage and electrical features, the voltage of every cell in a group will be inevitably different. This difference becomes more and more conspicuous after cycles of discharge and charge, and as a result, affects the service life and reliability of the entire serial battery system. In view of this, a battery voltage equalization control circuit is generally added in a serial battery system to reduce the voltage difference between individual cells in a battery group, thus increasing the cyclic life and reliability of the battery system.

The most commonly used battery voltage equalization control circuit adopts passive equalization. Each cell is connected in parallel with a resistor and a switch. The switch is controlled by the voltage equalization control circuit, which monitors the voltage of every cell and controls the applicable switch when the voltage of any cell is found exceptional. As shown in FIG. 1, this equalization method is implemented in two stages:

(1) Equalization During a Charging Process

In the process of charging, when the voltage of one cell is found higher than that of other cells, the equalization control circuit turns on the switch in parallel with the cell so that a portion of the charge current will be shunted to the resistor, and therefore, the charging speed of the cell of higher voltage is lowered so that the voltage of cells is consistent.

(2) Equalization During a Discharging Process

In the process of discharging, when the voltage of one cell is found higher than that of other cells, the equalization control circuit turns on the Qx switch in parallel with the cell so that the cell of higher voltage has two discharge loops: 1. load; 2. the parallel bypass resistor Rx. In this way, the voltage of the cell of higher voltage drops more quickly so that the voltage of cells is consistent.

The battery voltage equalization control circuit shown in FIG. 1 adopts passive equalization. Redundant energy (a cell of higher voltage stores redundant energy) is consumed by the equalization resistor R in the form of heat. The efficiency of the redundant energy is 0 while the system needs to deal with additional heat dissipation. In addition, the equalization switch, resistor and voltage equalization control circuit are usually integrated in a special control chip to save the space of a board. Due to the limit of the heat dissipation capacity of the chip, the equalized current will normally be within 100 mA. As a result, in the case of a large capacity battery system, the entire voltage equalization process may last eight hours or even longer.

### SUMMARY OF THE INVENTION

An objective of embodiments of the present invention is to provide a voltage equalization apparatus for a battery system so as to improve the utilization of battery energy. Accordingly, the embodiments of the present invention also provide a voltage equalization method for a battery system.

To achieve the objective above, the embodiments of the present invention provides a voltage equalization apparatus for a battery system with two or more serial cells. The voltage equalization apparatus includes:

a mutual inductor (such as a current mutual inductor or a voltage mutual inductor) or a transformer, which includes a primary winding, a magnetic core (such as an iron core) and a plurality of secondary windings;

a first switch, connected in series with the primary winding, wherein the first switch and the primary winding are connected in parallel with the battery system;

a plurality of second switches, respectively connected in series with the secondary windings, wherein the second switches and the secondary windings are connected in parallel with the cells; and

a voltage equalization control circuit, configured to: test voltage of each cell in the battery system and control turning off and turning on of the first switch and second switches; and when the battery system is charged, turn on a second switch in parallel with a cell of highest voltage, and after a first preset time turn off the second switch with the cell of highest voltage and turn on the first switch.

The embodiments of the present invention further provide another voltage equalization apparatus for a battery system. The voltage equalization apparatus includes:

a mutual inductor (such as a current mutual inductor or a voltage mutual inductor) or a transformer, which includes a primary winding, a magnetic core (such as an iron core) and a plurality of secondary windings;

a first switch, connected in series with the primary winding, wherein the first switch and the primary winding are connected in parallel with the battery system;

a plurality of second switches, respectively connected in series with the secondary windings, wherein the second switches and the secondary windings are connected in parallel with the cells; and

a voltage equalization control circuit, configured to: test voltage of each cell in the battery system and control turning off and turning on of the first switch and second switches; and when the battery system is discharged, turn on the first switch, and after a second preset time turn off the first switch and turn on a second switch in parallel with a cell of lowest voltage.

The embodiments of the present invention further provide a voltage equalization method for a battery system. The voltage equalization method includes:

judging whether the battery system is charged or discharged;

testing voltage of each cell in the battery system; and

when the battery system is charged, turning on a second switch in parallel with a cell of highest voltage, and turning off the second switch in parallel with a cell of highest voltage and turning on a first switch in parallel with the battery system after the second switch in parallel with a cell of highest voltage is on for a first preset time; or when the battery system is discharged, turning on the first switch in parallel with the battery system; and turning off the first switch and turning on the second switch in parallel with a cell of lowest voltage after the first switch is on for a second preset time;

wherein second switches are respectively connected in series with secondary windings of a mutual inductor or a transformer, and the second switches and the secondary windings are connected in parallel with the cells.

In the embodiments of the present invention, redundant energy is returned to the battery system through coupling of mutual inductor windings or transformer windings, and thus the utilization of battery energy is improved.

### BRIEF DESCRIPTION OF THE DRAWINGS

The accompanying drawings are provided herein to facilitate further understanding of the present invention, and constitute a part of the application without limiting the present invention. In the accompanying drawings:

FIG. 1 is a schematic drawing illustrating a circuit of a voltage equalization apparatus for a battery system in the prior art;

FIG. 2 is a schematic drawing illustrating a circuit of a voltage equalization apparatus for a battery system according to an embodiment of the present invention;

FIG. 3 is a block diagram showing a structure of a voltage equalization control circuit according to an embodiment of the present invention; and

FIG. 4 is a flowchart of a voltage equalization method for a battery system according to an embodiment of the present invention.

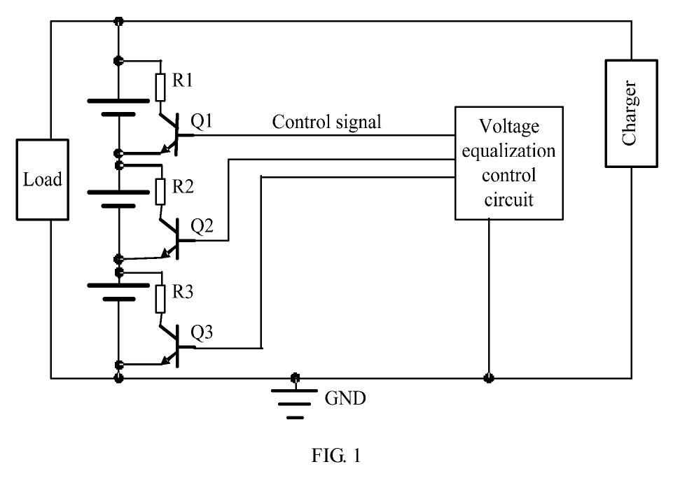

### DETAILED DESCRIPTION OF THE EMBODIMENTS

In an embodiment of the present invention, an active equalization control circuit with a transformer is added in a battery system of serial cells so that redundant energy is transferred between the battery system and a cell, thus achieving the purpose of equalizing the cell voltage and improving the utilization of battery energy. Embodiments of the present invention are described hereinafter with reference to a battery system made up of three serial cells. In the implement of the present invention, a battery system can be made up of two or more serial cells, and thus the number of serial cells in a battery system is not limited.

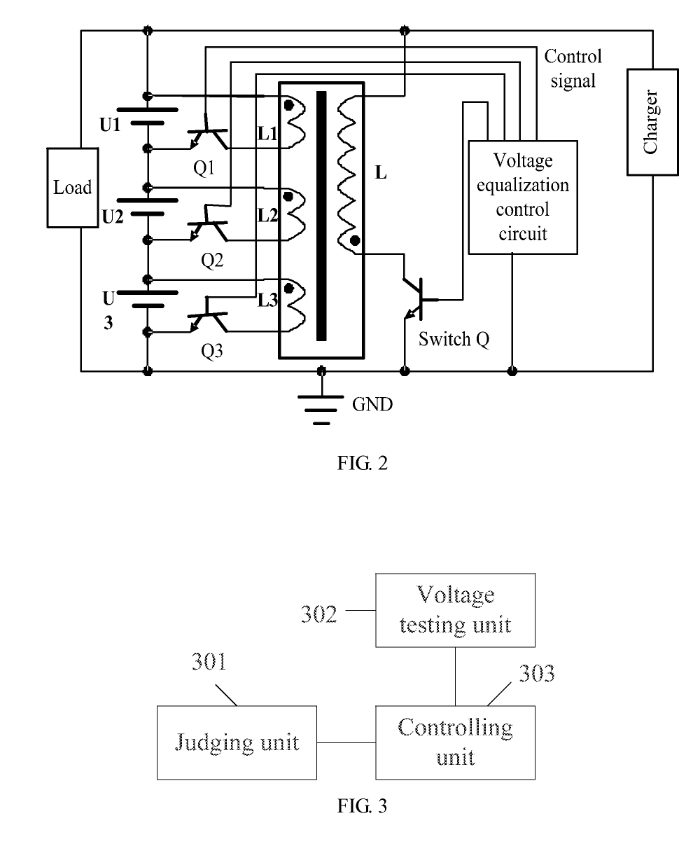

As shown in FIG. 2, a voltage equalization control circuit of the battery system includes a transformer, multiple switches and a voltage equalization control circuit. The transformer includes a primary winding L, a magnetic core (such as an iron core) and secondary windings (e.g., L1, L2 and L3). The primary winding and secondary windings are wound around the iron core. Specifically, in the circuit shown in FIG. 2, a transformer winding (e.g., secondary winding L1, L2 or L3) and a switch (e.g., Q1, Q2, or Q3) are in parallel with each cell in the serial battery system and a transformer winding (e.g., primary winding L) and a switch (e.g., Q) are in parallel with the entire battery system. The switches are turned off and turned on in turn under the control of the voltage equalization control circuit, which may be implemented by a special chip, or a logic circuit, or an analog circuit, so that energy is transferred between the entire battery system and individual cells. The transformer in FIG. 2 may also be a mutual inductor (such as a current mutual inductor or a voltage mutual inductor).

The voltage equalization control circuit of the battery system shown in FIG. 2 is able to realize equalization in both the process of charging and the process of discharging.

(1) Equalization During a Charging Process

When a charger charges the battery system, the voltage equalization control circuit first turns off all switches (e.g., Q1, Q2, Q3 and Q) and then tests the voltage of every cell all the time. When detecting that the voltage of one cell (suppose U3 in FIG. 2) is higher than that of other cells, the equalization control circuit starts the charge equalization process. Firstly, the switch Q3 in parallel with the cell U3 of the highest voltage is turned on so that the voltage of the cell U3 is imposed on the corresponding secondary winding L3. Because the inductance of the transformer winding will suppress sudden change of the current, the current passing through L3 will increase linearly and an inductive electromotive force (as shown in FIG. 2, with the black dot in the positive direction) is induced. The inductive electromotive force is equal to the cell voltage in the absolute value and reverse in polarity. When the current reaches a certain height, Q3 is turned off. Because the current of L3 is in linear increase, the intensity of current is determined according to the on-state time of Q3, which can be set and controlled by the voltage equalization control circuit. Normally, the on state lasts a few microseconds, or else the current on L3 will increase continuously until the current exceeds its saturation, which will result in a short-circuited cell. When Q3 is turned off, because the current on the secondary winding L3 drops to 0 instantaneously, an inverse inductive electromotive force is generated by L3 (with the black dot in FIG. 2 in the negative direction). Meanwhile, an inductive electromotive force is generated by the primary winding L due to mutual induction of the transformer. This electromotive force is also negative in the black dot direction. The voltage equalization control circuit turns on the primary switch Q. Then, the inductive electromotive force generated by L will flow out of the primary winding and be imposed on the common end of the load, charger and battery system. This means that redundant energy is transferred back to the power supply through coupling of the transformer winding to power the load and to charge the battery system. The on-state time of Q is also controlled and regulated by the equalization control circuit. When the preset on-state time elapses, the switch Q is turned off. This process runs cyclically so that he voltage equalization control circuit tests the cell voltage all the time and releases a portion of the energy of a higher voltage cell back for charging until the charging ends, and as a result, the problem that the entire system is not fully charged due to fast charging of one cell can be avoided.

(2) Equalization During a Discharging Process

When the battery system is discharged to loads, the voltage equalization control circuit first turns off all switches and then tests the voltage of every cell all the time. When detecting that the voltage of one cell (suppose U1 in FIG. 2) is lower than that of other cells, the equalization control circuit starts the discharge equalization process. Firstly, the primary switch Q is turned on so that all output voltage of the battery system is imposed on the primary winding L. Because the inductance of the transformer winding suppresses sudden change of current, the current passing through the winding L will increase linearly and an inductive electromotive force is generated by the winding L. The inductive electromotive force is equal to the system voltage in the absolute value and reverse in polarity (with the black dot in the negative direction as shown in FIG. 2). The on-state time of Q is controlled and regulated by the equalization control circuit. When a preset on-state time (indicating the current rises to certain intensity) elapses, the switch Q is turned off. The intensity of current is also deduced according to the on-state time. The on-state time is normally a few microseconds or else the current on L will rise continuously until the current exceeds its saturation, which will result in a short-circuited cell. When the switch Q is turn off, because the current on the primary winding changes instantaneously, the primary winding will generate an inverse inductive electromotive force (with the black dot in FIG. 2 in the positive direction). Meanwhile, the secondary winding L1 also generates an electromotive force which is positive in the black dot direction due to mutual induction of current or voltage. The equalization control circuit turns on the switch Q1 in parallel with the lower voltage cell U1. Then the inductive electromotive force generated by the secondary winding L1 connected to U1 will flow out because the on-state of Q1, to charge the lower voltage cell and increase the voltage of U1. As to the other secondary windings, because the corresponding switches are off, charge loops cannot be formed. The on-state time of Q1 is also controlled and regulated by the equalization control circuit. When the preset on-state time elapses, the switch Q1 is turned off. This process runs cyclically so that the voltage equalization control circuit tests cell voltage all the time and provides a portion of the energy of the battery system for a cell of lower voltage through coupling of the transformer until the energy of all cells is exhausted, and as a result, the problem that the entire battery system fails because of low voltage of one cell can be avoided.

To sum up, with the active equalization method in the foregoing embodiment of the present invention, redundant energy is returned to the battery system through coupling of transformer windings, with only a small portion of the energy lost in the process of winding coupling (the efficiency of coupling is generally above 80%). The utilization of battery energy is improved and the efficiency of voltage equalization with respect to serial batteries is higher, especially in high-power and high-current battery application environments.

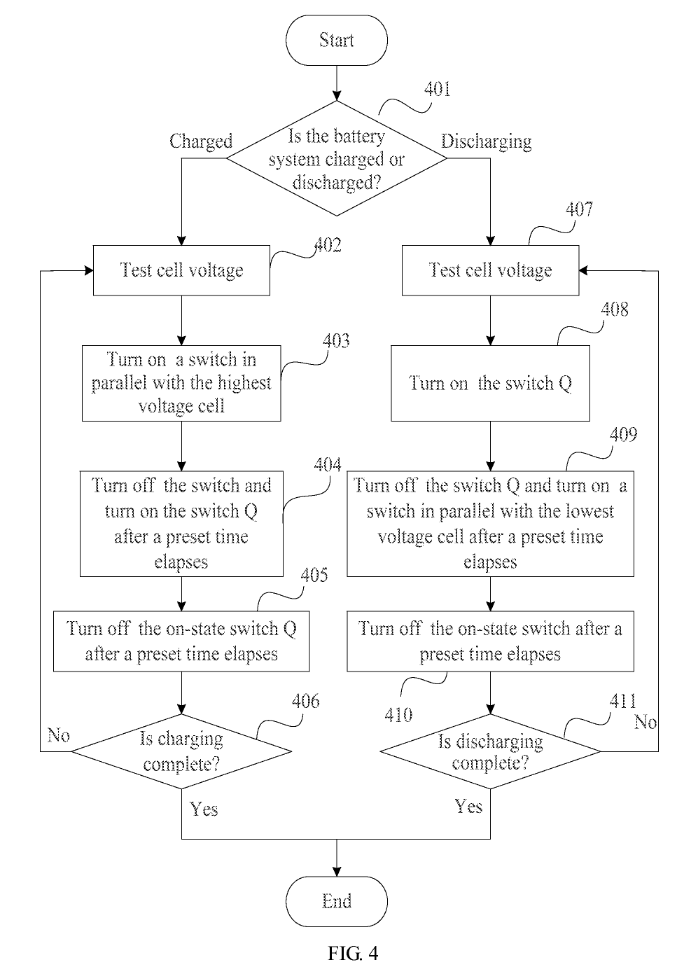

FIG. 3 is a block diagram illustrating a structure of the voltage equalization control circuit according to an embodiment of the present invention. As shown in FIG. 3, the voltage equalization control circuit includes: a judging unit 301, configured to judge whether the battery system is charged or discharged and generate an state signal; a voltage testing unit 302, configured to test voltage of each cell in the battery system; and a controlling unit 303, connected to the judging unit 301 and the voltage testing unit 302. The controlling unit 303 is configured to: turn on a switch (e.g., Q1, Q2, or Q3) in parallel with a cell of highest voltage when the battery system is charged, and then turn off the switch and turn on switch Q after a preset time elapses; and turn on the switch Q when the battery system is discharged, and then turn off the switch Q and turn on a switch (e.g., Q1, Q2, or Q3) in parallel with a cell of lowest voltage after a preset time elapses.

The controlling unit 303 further includes a resetting unit, configured to: turn off the switch Q of the battery system after the switch Q is on for a preset time in a charging process and turn off the switch Q1, Q2, or Q3 of the battery system after the switch Q1, Q2, or Q3 is on for a preset time in a discharging process.

The voltage equalization control circuit shown in FIG. 3 may be integrated in a special control chip by itself or be integrated in a special control chip together with the transformer and the switches.

In an embodiment of the present invention, the switches may be triodes, or metal-oxide-semiconductor field-effect transistors (MOSFETs), or other controllable parts that have the turn on and turned off states.

FIG. 4 is a flowchart of a voltage equalization method for a battery system using the circuit shown in FIG. 2. As shown in FIG. 4, the method includes:

Block 401: It is judged whether the battery system is charged or discharged; if the battery system is charged, the process proceeds to block 402, and if the battery system is discharged, the process proceeds to block 407.

Block 402: The voltage of each cell (e.g., U1, U2 and U3) is tested.

Block 403: A switch (such as Q3) in parallel with a cell of highest voltage (such as U3) is turned on.

Block 404: The switch (such as Q3) in parallel with a cell of highest voltage is turned off and the switch Q in series with a primary winding is turned on after a preset on-state time of the switch (such as Q3) elapses.

Block 405: The switch Q is turned off after a preset on-state time of the switch Q elapses.

Block 406: It is judged whether charging is complete, and if so, the process ends; otherwise, the process proceeds to block 402.

Block 407: The voltage of each cell (e.g., U1, U2 and U3) is tested.

Block 408: Turning on the switch Q in series with the primary winding.

Block 409: After a preset on-state time of the switch Q elapses, the switch Q is turned off and a switch (such as Q1) in parallel with a cell of lowest voltage (such as U1) is turned on.

Block 410: The switch (such as Q1) is turned off after a preset on-state time of the switch (such as Q1) elapses.

Block 411: It is judged whether discharging is complete, and if so, the process ends; otherwise, the process proceeds to block 407.

It is understandable to those skilled in the art that all or part of steps in the method of the preceding embodiments may be completed by hardware instructed by a program. The program may be stored in a computer readable storage medium, for example, a read-only memory or a random access memory (ROM/RAM), a magnetic disk, and a compact disk.

Although the objective, technical solution and benefits of the present invention have been described in detail through exemplary embodiments, the invention is not limited to such embodiments. It is apparent that those skilled in the art can make various modifications and variations the invention without departing from the spirit and scope of the present invention. The invention is intended to cover the modifications and variations provided that they fall in the scope of protection defined by the claims or their equivalents.

What is claimed is:

1. A voltage equalization apparatus for a battery system with more than two serial cells, comprising:
a mutual inductor or a transformer, comprising a primary winding, a magnetic core and a plurality of secondary windings;
a first switch, connected in series with the primary winding, wherein the first switch and the primary winding are connected in parallel with the battery system;
a plurality of second switches, respectively connected in series with the secondary windings, wherein the second switches and the secondary windings are connected in parallel with the cells; and
a voltage equalization control circuit, configured to: test voltage of each cell in the battery system and control turning off and turning on of the first switch and second switches; and when the battery system is charged, turn on a second switch in parallel with a cell of highest voltage, and after a first preset time turn off the second switch with the cell of highest voltage and turn on the first switch.

2. The apparatus of claim 1, wherein the voltage equalization control circuit is further configured to: when the battery system is discharged, turn on the first switch, and after a second preset time turn off the first switch and turn on a second switch in parallel with a cell of lowest voltage.

3. The apparatus of claim 2, wherein the voltage equalization control circuit comprises:
a judging unit, configured to judge whether the battery system is charged or discharged and generate a state signal;
a voltage testing unit, configured to test voltage of each cell in the battery system; and
a controlling unit, connected to the judging unit and the voltage testing unit, and configured to: turn on the second switch in parallel with the cell of highest voltage when the battery system is charged, and turn off the second switch in parallel with the cell of highest voltage and turn on the first switch after the first preset time; or turn on the first switch when the battery system is discharged, and turn off the first switch and turn on the second switch in parallel with the cell of lowest voltage after the second preset time.

4. The apparatus of claim 2, wherein the voltage equalization control circuit further comprises:
a resetting unit, connected to the controlling unit, and configured to: turn off the first switch after the first switch is on for a third preset time when the battery system is charged; or turn off the second switch in parallel with the cell of lowest voltage after the second switch in parallel with the cell of lowest voltage is on for a fourth preset time when the battery system is discharged.

5. The apparatus of claim 1, wherein:
the first switch and the second switches are triodes or metal-oxide-semiconductor field-effect transistors, MOSFETs.

6. The apparatus of claim 1, wherein the voltage equalization control circuit comprises:
a voltage testing unit, configured to test voltage of each cell in the battery system; and
a controlling unit, connected to the judging unit and the voltage testing unit, and configured to: turn on the second switch in parallel with the cell of highest voltage when the battery system is charged, and turn off the second switch in parallel with the cell of highest voltage and turn on the first switch after the first preset time.

7. The apparatus of claim 1, wherein the voltage equalization control circuit further comprises:
a resetting unit, connected to the controlling unit, and configured to: turn off the first switch after the first switch is on for a third preset time when the battery system is charged.

8. A voltage equalization apparatus for a battery system with more than two serial cells, comprising:
a mutual inductor or a transformer, comprising a primary winding, a magnetic core and a plurality of secondary windings;
a first switch, connected in series with the primary winding, wherein the first switch and the primary winding are connected in parallel with the battery system;
a plurality of second switches, respectively connected in series with the secondary windings, wherein the second switches and the secondary windings are connected in parallel with the cells; and
a voltage equalization control circuit, configured to: test voltage of each cell in the battery system and control turning off and turning on of the first switch and second switches; and when the battery system is discharged, turn on the first switch, and after a second preset time turn off the first switch and turn on a second switch in parallel with a cell of lowest voltage.

9. The apparatus of claim 8, wherein the voltage equalization control circuit comprises:
a voltage testing unit, configured to test voltage of each cell in the battery system; and
a controlling unit, connected to the judging unit and the voltage testing unit, and configured to: turn on the first switch when the battery system is discharged, and turn off the first switch and turn on the second switch in parallel with the cell of lowest voltage after the second preset time.

10. The apparatus of claim 8, wherein the voltage equalization control circuit further comprises:
a resetting unit, connected to the controlling unit, and configured to: turn off the second switch in parallel with the cell of lowest voltage after the second switch in parallel with the cell of lowest voltage is on for a fourth preset time when the battery system is discharged.

11. A voltage equalization method for a battery system with more than two serial cells, comprising:
judging whether the battery system is charged or discharged;
testing voltage of each cell in the battery system; and
when the battery system is charged, turning on a second switch in parallel with a cell of highest voltage, and turning off the second switch in parallel with a cell of highest voltage and turning on a first switch in parallel with the battery system after the second switch in parallel with a cell of highest voltage is on for a first preset time; or when the battery system is discharged, turning on the first switch in parallel with the battery system; and turning off the first switch and turning on the second switch in parallel with a cell of lowest voltage after the first switch is on for a second preset time;
wherein second switches are respectively connected in series with secondary windings of a mutual inductor or a transformer, and the second switches and the secondary windings are connected in parallel with the cells.

12. The method of claim 11, further comprising:
when the battery system is charged, turning off the first switch after the first switch is on for a third preset time, or when the battery system is discharged, turn off the second switch in parallel with a cell of lowest voltage after the second switch in parallel with a cell of lowest voltage is on for a fourth preset time.
